(19) United States
(12) Patent Application Publication
(10) Pub. No.: US 2007/0122109 A1
(43) Pub. Date: May 31, 2007

(54) Method and apparatus for checking overlap of reservation recordings, and recording medium storing program for executing the same

(75) Inventor: Hyung-jin Seo, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/522,957

(22) Filed: Sep. 19, 2006

(30) Foreign Application Priority Data
Nov. 29, 2005 (KR) 10-2005-0115059

(51) Int. Cl. H04N 5/91

(52) U.S. Cl. 386/83

(57) ABSTRACT

A method of checking overlap of reservation recordings in a content storage includes converting input reservation recording data into a valid unit of reservation recording data, and checking whether the valid unit of reservation recording data is overlapped with reservation recording data stored in the content storage based on the valid unit. Application fields of the reservation recording overlap check can increase depending on operational conditions and environments of a content storage.

### CROSS-REFERENCE TO RELATED APPLICATIONS

This application claims priority from Korean Patent Application No. 10-2005-0115059, filed on Nov. 29, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to reservation recording in a device capable of storing various types of contents, and more particularly, to checking overlap of reservation recordings.

2. Description of the Related Art

In devices capable of storing various types of contents (hereinafter, referred to as a content storage), such as a personal video recorder (PVR) and a digital video recorder (DVR), a reservation recording function is indispensable. The reservation recording function is to check overlap of the reservation recordings for preventing overlap of the reservation. In such a reservation recording overlap check, when the reservation recording data is input, it is checked whether the input reservation recording data is overlapped with existing reservation recording data.

However, in the related art reservation recording function, after the recording data is input, the input reservation recording data is compared one-by-one with the existing reservation recording data to check their overlap. For example, if a user wants to record a television (TV) program broadcasted in a channel CH11 at 10 am˜11 am, on Nov. 24, 2005, and inputs reservation recording data codes “2005/Nov.24./10am-11am/CH11”, the related art reservation recording function is operated such that the input reservation recording data is converted into a particular type of codes, and it is checked whether there is reservation recording data identical to the codes “2005/Nov.24./10am-11am/CH11” among the existing reserved data. As a result, if there is no reservation recording data having identical codes, the input reservation recording data is stored in a content storage.

As such, in the related art reservation recording function, the reservation recording overlap check is performed in a one-to-one fashion by using the codes considering all the input reservation recording data “2005/Nov.24/10am-11am/CH11”. In other words, in the related art reservation recording function, the reservation recording overlap check is performed by using the codes considering all the input reservation recording data even when the input reservation recording data is different from the reservation year of the existing reservation data. Therefore, the reservation recording overlap check requires a lot of operations as well as redundant operations.

Also, if a repeated reservation recording is used in the related art reservation recoding function, it should be checked whether each of the reservation recording data for the TV program to be repeated recorded is overlapped with each of the existing reservation recording data. For example, if a reservation recording data “10 am˜11 am, every Saturday/Tuesday, November 2005, CH11” is input, the related art reservation recording function will generate: 2005/Nov.1/10-11am/CH11, 2005/Nov.2/10-11am/CH11, 2005/Nov.8/10-11am/CH11, 2005/Nov.9/10-11am/CH11, 2005/Nov.15/10-11am/CH11, 2005/Nov.16/10-11am/CH11, 2005/Nov.22/10-11am/CH11, 2005/Nov.29/10-11am/CH11, and 2005/Nov.30/10-11am/CH11 as input reservation recording data.

Then, the related art reservation recording function is operated to respectively check whether the generated reservation recording data is overlapped with the existing reservation recording data. If the number of the existing reservation recording data is one, the related art reservation function performs reservation recording overlap checks for the input reservation recording data 10 times. If the number of the existing reservation data is 10, the related art reservation function performs 100 times (10×10) of reservation recording overlap checks for the input reservation recording data. In this case, since the related art reservation recording function performs the reservation recording overlap checks by using the codes generated by considering all of the reservation recording data as described above, the repeated reservation recording of the related art reservation recording function requires more operations as well as more times for the reservation recording overlap checks in comparison with a general reservation recording.

In addition, in the repeated reservation recording as described above, if it is determined by the related art reservation recording function that the input reservation recording data is not overlapped, all the reservation recording data is stored in the content storage. Specifically, if reservation recording data “10 am˜11 am, every Tuesday/Wednesday, November 2005, CH11” is input, and the input reservation recording data is not overlapped with the existing reservation recording data, the related art reservation recording function is operated to store all of the reservation recording data including: 2005/Nov.1/10-11am/CH11, 2005/Nov.2/10-11am/CH11, 2005/Nov.8/10-11am/CH11, 2005/Nov.9/10-11am/CH11, 2005/Nov.15/10-11am/CH11, 2005/Nov.16/10-11am/CH11, 2005/Nov.22/10-11am/CH11, 2005/Nov.29/10-11am/CH11, and 2005/Nov.30/10-11am/CH11 as input reservation recording data in the content storage. Therefore, in the related art reservation recording function, a period capable of a reservation recording is limited to a short period depending on a storage capacity of the content storage.

### SUMMARY OF THE INVENTION

The present invention provides a method and apparatus for checking overlap of a reservation recording faster and more efficiently in various types of content storages, and a recording medium storing a program for executing the same.

Also, the present invention provides a method and apparatus for checking overlap of a reservation recording, by which the amount of the data required for the reservation recording can be reduced in various types of content storages, and a recording medium storing a program for executing the same.

Also, the present invention provides a method and apparatus for checking overlap of a reservation recording, by which it is possible to rapidly check whether the reservation recording is overlapped even with a small amount of operations in various types of content storages, and a recording medium storing a program for executing the same.

Also, the present invention provides a method and apparatus for checking overlap of a reservation recording by considering channels in various types of content storages having a multi-tuner, and a recording medium storing a program for executing the same.

Also, the present invention provides a method and apparatus for checking overlap of a reservation recording by considering user's priorities in various types of content storages in a multi-user environment, and a recording medium storing a program for executing the same.

According to an aspect of the present invention, there is provided a method of checking overlap of reservation recordings in a content storage, the method comprising: a) converting input reservation recording data into a valid unit of reservation recording data; and b) checking whether the valid unit of reservation recording data is overlapped with at least one of reservation recording data stored in the content storage based on the valid unit.

According to another aspect of the present invention, there is provided an apparatus for checking overlap of reservation recordings in a content storage, the apparatus comprising: a parser parsing input reservation recording data; a day-of-the-week data supply unit; a data conversion unit converting the input reservation recording data into a valid unit of reservation recording data based on parsed data from the parser and day-of-the-week data from the day-of-the-week data supply unit; a storage unit storing reservation data; and an overlap check unit checking whether the valid unit of reservation recording data is overlapped with reservation recording data stored in the storage unit. 1161 According to still another aspect of the present invention, there is provided a computer-readable medium having embodied thereon a computer program for executing a method of checking overlap of reservation recordings in a content storage, the medium comprising codes for: converting input reservation recording data into a valid unit of reservation recording data; and checking whether the valid unit of reservation recording data is overlapped with at least one of reservation recording data stored in the content storage based on the valid unit.

### BRIEF DESCRIPTION OF THE DRAWINGS

The above and other aspects of the present invention will become more apparent by describing in detail exemplary embodiments thereof with reference to the attached drawings in which:

FIG. 1 is a functional block diagram illustrating a reservation recording overlap check apparatus according an exemplary embodiment of the present invention;

FIG. 2 illustrates a data conversion unit of FIG. 1 according to an exemplary embodiment of the present invention;

FIG. 3 illustrates a valid unit of reservation recording data structure according to an exemplary embodiment of the present invention;

FIGS. 4A and 4B illustrate day-of-the-week pattern data according an exemplary embodiment of the present invention;

FIGS. 4C and 4D illustrate correction of a reservation time and an overlap check of a reservation time based on day-of-the-week pattern data of FIGS. 4A and 4B;

FIG. 5 illustrates another data conversion unit of FIG. 1 according to an exemplary embodiment of the present invention;

FIG. 6 illustrates another valid unit of reservation recording data structure according to an exemplary embodiment of the present invention;

FIG. 7 is a flowchart illustrating operation in a method of checking overlap of a reservation recording according to another exemplary embodiment of the present invention;

FIG. 8 illustrates detailed flows of operation of checking overlap of the reservation recording data shown in FIG. 7 according to another exemplary embodiment of the present invention;

FIG. 9 illustrates another detailed flows of operation of checking overlap of the reservation recording data shown in FIG. 7 according to another exemplary embodiment of the present invention; and

FIG. 10 illustrates still detailed flows of operation of checking overlap of the reservation recording data shown in FIG. 7 according to another exemplary embodiment of the present invention.

### DETAILED DESCRIPTION OF EXEMPLARY EMBODIMENTS OF THE INVENTION

The attached drawings for illustrating exemplary embodiments of the present invention are referred to in order to gain a sufficient understanding of the present invention, the merits thereof, and the objectives accomplished by the implementation of the present invention.

Exemplary embodiments of the present invention will now be described in detail with reference to the accompanying drawings.

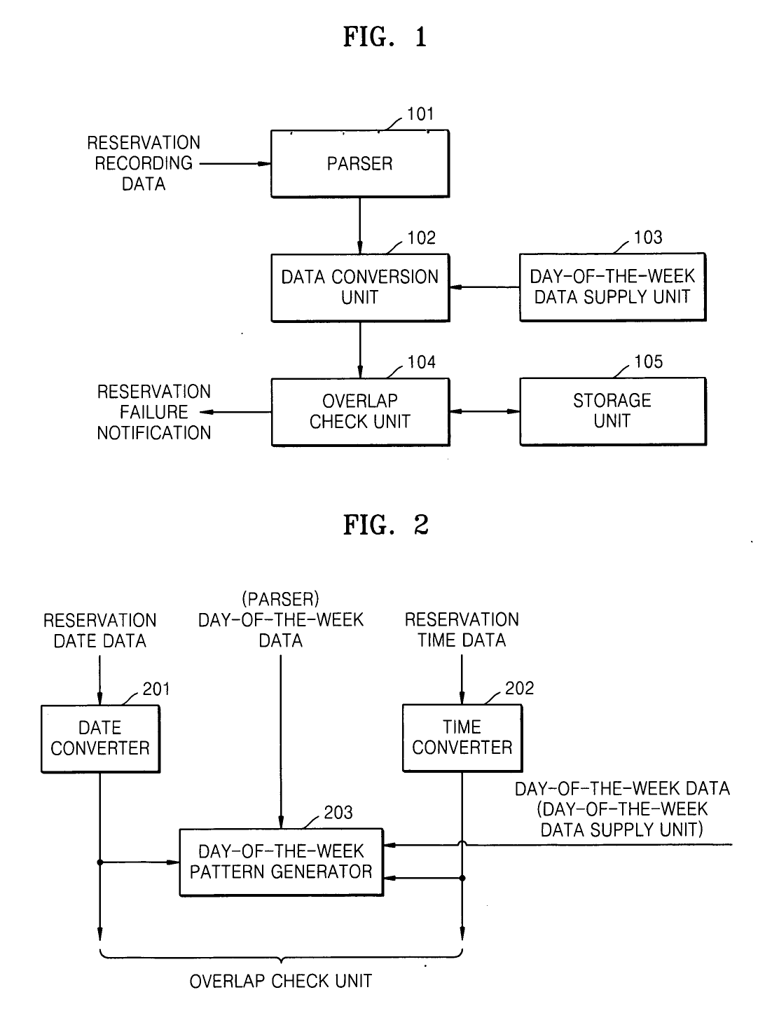

FIG. 1 is a functional block diagram illustrating a reservation recording overlap check apparatus according to an exemplary embodiment of the present invention. The reservation recording overlap check apparatus shown in FIG. 1 can be included in a device capable of storing various contents. The device capable of storing various contents may be, for example, a personal video recorder (PVR) or a digital video recording (DVR) having a high capacity of storage.

Referring to FIG. 1, the reservation recording overlap check apparatus includes a parser 101, a data conversion unit 102, a day-of-the-week data supply unit 103, an overlap check unit 104, and a storage unit 105.

The parser 101 parses the input reservation recording data. Specifically, a set of reservation date data and reservation time data, or a set of reservation date data, reservation time data, and additional data included in the input reservation recording data are parsed, respectively, and then output. A set of the reservation date data and the reservation time data, or a set of the reserved date data, the reservation time data, and the additional data that have been output are transmitted to the data conversion unit 102. In this case, if the day-of-the-week data is included in the input reservation recording data, the parser 101 also parses the day-of-the-week data from the input reservation recording data and transmits it to the data conversion unit 102.

The data conversion unit 102 converts the input reservation recording data into reservation recording data having a valid unit of reservation recording data structure based on the data parsed by the parser 101 and the day-of-the-week data provided from the day-of-the-week data supply unit 103.

For this purpose, the data conversion unit 102 may be configured as shown in FIG. 2. FIG. 2 illustrates an example of the data conversion unit of FIG. 1 according to an exemplary embodiment of the present invention. Referring to FIG. 2, the data conversion unit 102 includes a date converter 201, a time converter 202, and a day-of-the-week pattern generator 203.

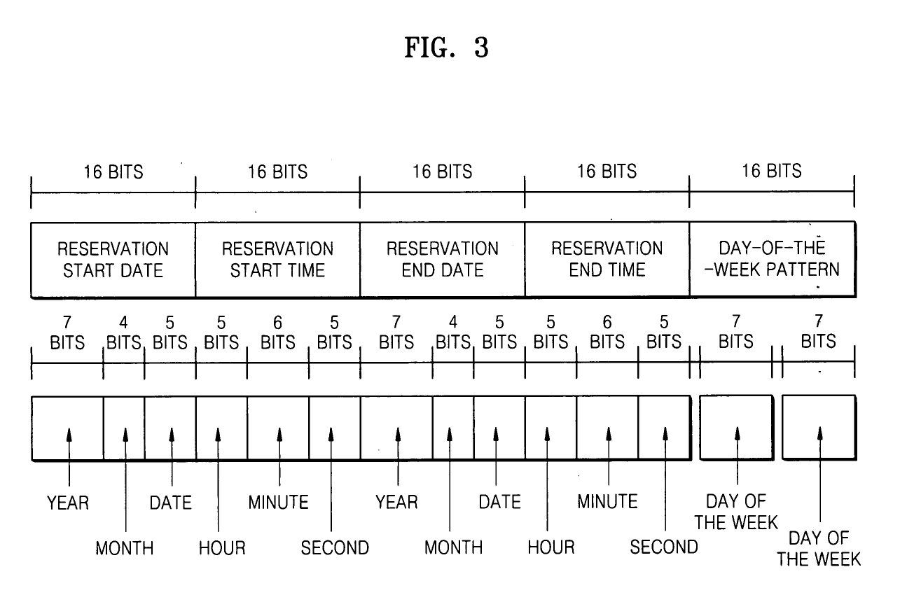

The date converter 201 converts the reservation date data provided from the parser 101 into bit data, and outputs the converted bit data to the overlap check unit 104 and the day-of-the-week pattern generator 203, respectively. In other words, if numerical data relating to the reservation start date and the reservation end date are input from the parser 101, the date converter 201 converts them into 16-bit data, respectively, and output them as shown in FIG. 3.

FIG. 3 illustrates a valid unit of reservation recording data structure according to an exemplary embodiment of the present invention. The valid unit of reservation recording data structure shown in FIG. 3 consists of 16 bits for the reservation start date field, 16 bits for the reservation start time field, 16 bits for the reservation end date field, 16 bits for the reservation end time field, and 16 bits for the day-of-the-week pattern field.

The reservation start date field consists of 7 bits for the reservation year field, 4 bits for the reservation month field, 5 bits for the reservation date field, respectively. The reservation start time field consists of 5 bits for the reservation hour field, 6 bits for the reservation minute field, and 5 bits for the reservation second field. The reservation end date field consists of 7 bits for the reservation year field, 4 bits for the reservation month field, and 5 bits for the reservation date field. The reservation end time field consists of 5 bits for the reservation hour field, 6 bits for the reservation minute field, and 5 bits for the reservation second field. The day-of-the-week pattern field consists of 7 bits for the day-of-the-week start pattern field, and 7 bits for the day-of-the-week end pattern field.

Therefore, the date converter 201 outputs the bit data to be included in the reservation start date field and the reservation end date field. The data included in the reservation start date field and the reservation end date field can be identical to each other if the recoding does not correspond to the repeated reservation recording. If the recording corresponds to the repeated reservation recording, the data contained in the reservation start date field is the date in which a program is initially reserved, and the data included in the reservation end date is the date in which a program is finally reserved. For example, if a user wants to record a TV program broadcasted at 10 am˜11 am on every Tuesday/Wednesday from Nov.1, 2005 to Nov. 30, 2005, the data contained in the reservation start date field are the bit data corresponding to Nov. 1, 2005, and the data contained in the reservation end date field are the bit data corresponding to Nov. 30, 2005.

The time converter 202 converts the reservation time data provided from the parser 101 into corresponding bit data, and outputs the converted bits data to the day-of-the-week pattern generator 203 and the overlap check unit 104 respectively. In other words, if numerical data for the reservation start time and the reservation end time are input from the parser 101, the time converter 202 converts them into 16-bit data and outputs them as shown in FIG. 3. For example, if a user wants to record a TV program broadcasted at 10 am˜11 am on every Tuesday/Wednesday from Nov. 1, 2005 to Nov. 30, 2005, the data contained in the reservation start time field is the bit data corresponding to 10 am, and the data contained in the reservation end time field is the bit data corresponding to 11 am.

The day-of-the-week generator 203 generates the day-of-the-week pattern data based on the bit data output from the date converter 201, the bit data output from the time converter 202, and the day-of-the-week data provided from the day-of-the-week supply unit 103 or the parser 101, and then outputs the generated day-of-the-week pattern data to the overlap check unit 104.

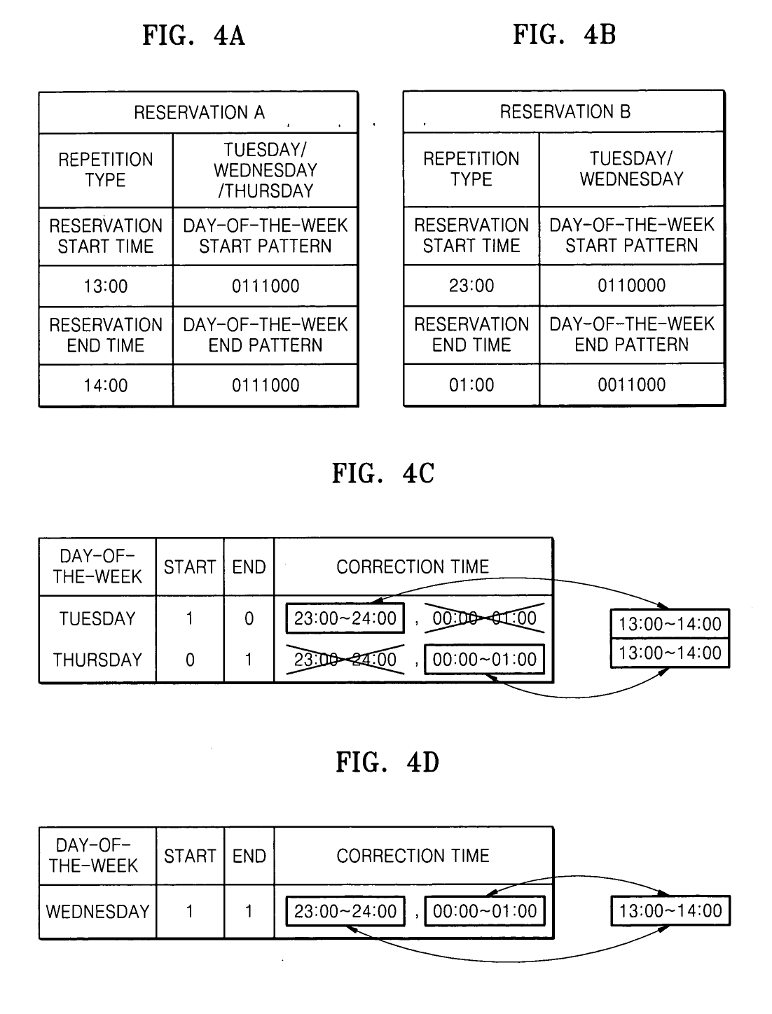

In other words, if corresponding day-of-the-week data is obtained from the day-of-the-week supply unit 103 based on the bit data output from the date converter 201, or the day-of-the-week data is supplied from the parser 101, the day-of-the-week pattern generator 203 generates the day-of-the-week pattern based on the bit data for the reservation start time and the reservation end time provided from the time converter 202 as shown in FIGS. 4A and 4B, which illustrate an example of the day-of-the-week pattern data.

FIG. 4A shows an example of the reservation recording data when a program should be repeatedly recorded from 13:00:00 to 14:00:00 on every Tuesday, Wednesday, and Thursday. In FIG. 4A, since the reservation start time is 13:00, which is included in a corresponding day of the week, the day-of-the-week start pattern is generated as “0111000(Monday-Tuesday-Wednesday-Thursday-Friday-Saturday-Sunday)”. Since the reservation end time is 14:00, which is included in a corresponding day of the week, the day-of-the-week end pattern is generated as “0111000(Monday-Tuesday-Wednesday-Thursday-Friday-Saturday-Sunday)”.

FIG. 4B shows an example of reservation recording data when a program should be repeatedly recorded from 23:00 to 01:00 of a next day every Tuesday and Wednesday. In FIG. 4B, the reservation start time is 23:00, which is included in a corresponding day of the week, the day-of-the-week start pattern is generated as “0110000(Monday-Tuesday-Wednesday-Thursday-Friday-Saturday-Sunday)”. Since the reservation end time is 1:00 of a next day, which is not included in a corresponding day of the week, the day-of-the-week end pattern is generated as “0011000(Monday-Tuesday-Wednesday-Thursday-Friday-Saturday-Sunday)”.

The generated day-of-the-week data is transmitted to the overlap check unit 104.

If the data conversion unit 102 is configured as shown in FIG. 2, the overlap check unit 104 checks whether the reservation recording data is overlapped based on the reservation recording data structure shown in FIG. 3. The reservation recording data overlap check will be described below in more detail in association with the overlap check unit 104.

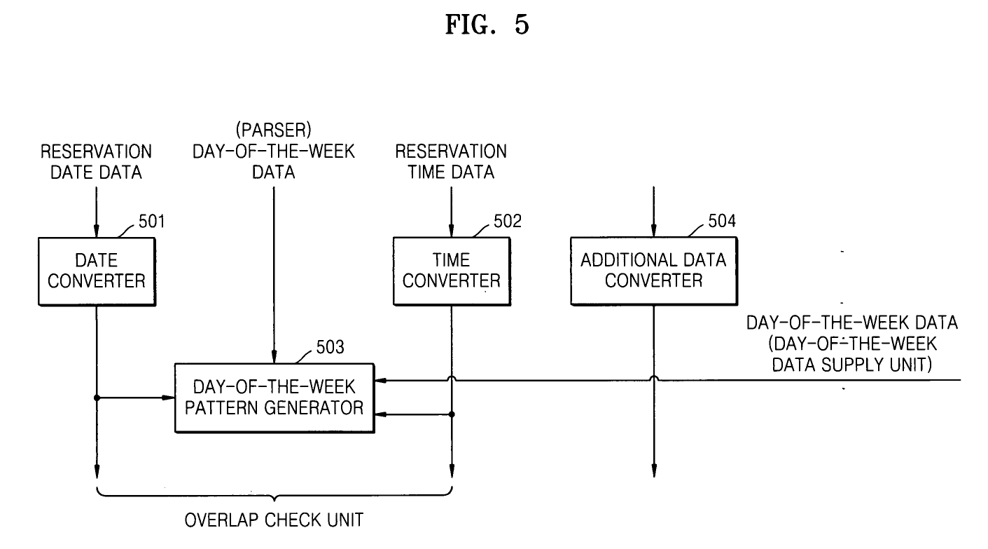

Meanwhile, the data conversion unit 102 may be configured as shown in FIG. 5. Referring to FIG. 5, the data conversion unit 102 includes a date converter 501, a time converter 502, a day-of-the-week pattern generator 503, and an additional data converter 504.

The date converter 501, the time converter 502, and the day-of-the-week generator 503 are configured and operated similar to those shown in FIG. 2.

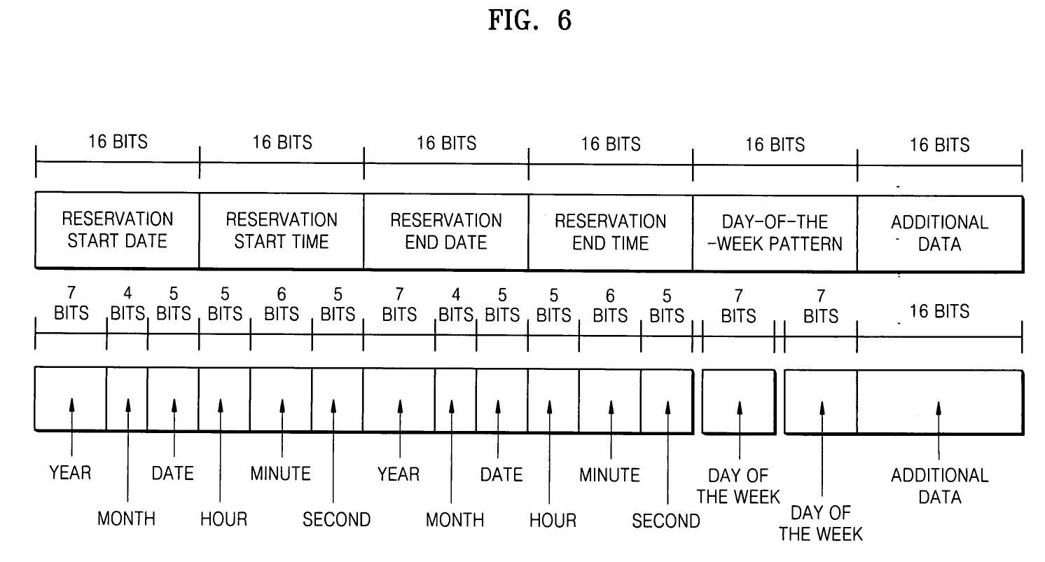

The additional data converter 504 converts the additional data provided from the parser 101 into bit data, and provides the converted bit data to the overlap check unit 104. The additional data may include information on a channel providing a desired program or user's priorities. The channel information is prepared for considering a case that a content storage applied to the present invention has a dual-tuner. The information on the user's priorities is prepared for considering a case that the content storage applied to the present invention is operated in a multi-user environment. As shown in FIG. 6, the additional data converter 504 provides the 16 bit converted additional data to the overlap check unit 104.

Accordingly, if the data conversion unit 102 is configured as shown in FIG. 5, the overlap check unit 104 checks overlap of reservation recording data based on the reservation recording data structure shown in FIG. 6.

The day-of-the-week supply unit 103 provides day-of-the-week data corresponding to the date data. For this purpose, the day-of-the-week data supply unit 103 may store calendar data.

The overlap check unit 104 checks whether the reservation recording data having a valid unit of reservation recording data structure shown in FIG. 3 or 6 is overlapped with the reservation recording data stored in the storage unit 105.

In other words, when a valid unit of reservation recording data structure is similar to that shown in FIG. 3, the overlap check unit 104 performs an overlap check in the order of a reservation period, a day-of-the week pattern, and a reservation time.

First, the overlap check unit 104 checks whether the reservation period in the reservation recording data having a valid unit of reservation recording data structure is overlapped with the reservation period of the reservation recording data stored in the storage unit 105 based on a difference between the data contained in the reservation start date field and the reservation end date field. Checking whether the reservation periods are overlapped based on the difference between the data contained the fields can be made because a valid unit of reservation recording data structure is configured from a large scale to a small scale (i.e., year-month-day, hour-minute-second). In other words, a valid unit of reservation recording data structure is defined such that the bit data of Nov. 28, 2005 is larger than that of Nov. 27, 2005.

A condition that the reservation periods are not overlapped is that the data contained in the reservation end date field of the reservation recording data having a valid unit of reservation recording data structure should precede the data contained in the reservation start date field of the reservation recording data stored in the storage unit 105, and the data contained in the reservation end date field of the reservation recording data stored in the storage 105 should precede the data contained in the reservation start date field of the reservation recording data having a valid unit of reservation recording data structure. That is to say, a condition that the reservation periods are not overlapped is that the bit data contained in the reservation end date field of the reservation recording data having a valid unit of reservation recording data structure should be smaller than the bit data contained in the reservation start date field of the reservation recording data stored in the storage unit 105, and the bit data contained in the reservation end date field of the reservation recording data stored in the storage 105 should be smaller than the bit data contained in the reservation start date field of the reservation recording data having a valid unit of reservation recording data structure.

As a result of the check, if the reservation recording data having a valid unit of reservation recording data structure is overlapped with the reservation period of the reservation recording data stored in the storage 105, the overlap check unit 104 checks whether the reservation recording data having a valid unit of reservation recording data structure is overlapped with the reservation recording data stored in the storage 105 for the day-of-the-week pattern based on the data contained in the day-of-the-week field.

In other words, FIGS. 4A and 4B illustrate a case that the day-of-the-week pattern is overlapped. Specifically, in FIG. 4A, a logical OR operation is performed between the day-of-the-week start pattern “0111000” and the day-of-the-week end pattern “0111000”, thereby resulting in “0111000”. In FIG. 4B, a logical OR operation is performed between the day-of-the-week start pattern “0110000” and the day-of-the-week end pattern “0011000”, thereby resulting in “0111000”. Then, a logical AND operation is performed between the result of FIG. 4A and the result of FIG. 4B. If the result of the logical AND operation is “0”, it is determined that the day-of-the-week patterns of the reservations A and B are not overlapped with each other. However, indeed, the result of the logical AND operation is not “0”. Therefore, it is determined that the day-of-the-week patterns of the reservations A and B are overlapped with each other.

As such, a condition that the day-of-the-week patterns of the reservations A and B are not overlapped is defined as “((day-of-the-week start pattern of reservation A) OR (day-of-the-week end pattern of reservation A)) AND ((day-of-the-week start pattern of reservation B) OR (day-of-the-week end pattern of reservation A))=0”.

As a result of the check, if it is determined that the day-of-the-week pattern stored in the storage unit 105 is overlapped with that of the reservation recording data having a valid unit of reservation recording data structure, the overlap check unit 104 checks whether the reservation time of the reservation recording data stored in the storage unit 105 is overlapped with that of the reservation recording data having a valid unit of reservation recording data structure based on the data contained in the reservation end time field and the reservation start time field.

When checking overlap of the reservation time, the overlap check unit 104 corrects the reservation time data if the bit data on the reservation start time is larger than the bit data on the reservation end time, and performs the overlap check for the reservation time based on the corrected reservation time data. For example, as shown in FIGS. 4A and 4B, the day-of-the-week pattern of the reservation A (i.e., the reservation recording data having a valid unit of reservation recording data structure) is overlapped with that of the reservation B (i.e., the reservation recording data stored in the storage unit 105), the reservation start time and the reservation end time are compared for the reservations A and B. As a result of comparison, if the reservation start time is larger than the reservation end time, the overlap check unit 104 corrects the corresponding reservation time.

In the case of FIG. 4B, the reservation time should be corrected. Therefore, as shown in FIG. 4C, the reservation time 23:00-01:00 of FIG. 4B is divided into 23:00-24:00 and 00:00-01:00. However, as shown in FIG. 4C, the day-of-the-week start pattern of Tuesday is “1”, the day-of-the-week end pattern of Tuesday is “0”, and the time 23:00-24:00 of Tuesday of the divided reservation time is valid and thus, comparable with the reservation time of the reservation A. However, the time 00:00-01:00 of Tuesday is not valid and thus, not comparable with the reservation time of the reservation A.

Meanwhile, since both the day-of-the-week start pattern and the day-of-the-week end pattern of Wednesday are “1”, and both the divided times 23:00-24:00 and 00:00-01:00 are valid, they are compared with the reservation time of the reservation A as shown in FIG. 4D. In addition, as shown in FIG. 4C, the bit data of the day-of-the-week start pattern of Thursday is “0”, and the bit data of the day-of-the-week end pattern is “1”. Also, the time 23:00-24:00 is not valid, but the time 00:00-01:00 is valid. Therefore, it is compared with the reservation time of the reservation A.

The reservation times of the reservations A and B shown in FIG. 4 are not overlapped with each other. However, if it is determined that the reservation times are overlapped with each other, the overlap check unit 104 outputs a reservation fail notification for the input reservation recording data. The output reservation fail notification may be provided to a user.

Meanwhile, if the reservation recording data having a valid unit of reservation recording data structure is not overlapped with the all the reservation recording data stored in the storage unit 105 for at least one of the reservation time, the day-of-the-week pattern, and the reservation time, the overlap check unit 104 stores the reservation recording data having a valid unit of reservation recording data structure in the storage unit 105. The reservation recording data stored in the storage unit 105 has a reservation recording data structure shown in FIG. 3.

When the reservation recording data having a valid unit of reservation recording data structure is similar to those shown in FIG. 6, the overlap check unit 104 performs an overlap check in the order of the reservation period, the day-of-the-week pattern, the reservation time, and the additional data.

If the reservation recording data having a valid unit of reservation recording data structure is overlapped with at least one of the reservation recording data stored in the storage unit 105 for the reservation period, the day-of-the-week pattern, the reservation time, and the additional data, the overlap check unit 105 outputs a reservation failure notification for the input reservation recording data. The additional data may include channel information or user's priorities as described in association with FIG. 6.

However, if the reservation recording data having a valid unit of reservation recording data structure is not overlapped with all the reservation recording data stored in the storage unit 105 for at least one of the reservation period, the day-of-the-week pattern, and the reservation time, the overlap check unit 105 store the reservation recording data having a valid unit of reservation recording data structure in the storage unit 105.

If the reservation recording data having a valid unit of reservation recording data structure is overlapped with at least one of the reservation recording data stored in the storage unit 105 for the reservation period, the day-of-the-week pattern, and the reservation time, but not for the additional data, and if the reservation recording data having a valid unit of reservation recording data structure has a higher priority than that of at least one of the reservation recording data stored in the storage unit 105, the overlap check unit 104 deletes at least one of the reservation recording data stored in the storage unit 105 and stores the reservation recording data having a valid unit of reservation recording data structure in the storage unit 105.

However, supposing that a content storage applied to the present invention has a multi-tuner, if the reservation recording data having a valid unit of reservation recording data structure is overlapped with at least one of the reservation recording data stored in the storage unit 105 for the reservation period, the day-of-the-week pattern, and the reservation time, but not for the additional data, and if the reservation recording data having a valid unit of reservation recording data structure has a higher priority than that of at least one of the reservation recording data stored in the storage unit 105, the overlap check unit 104 deletes at least one of the reservation recording data stored in the storage unit 105 even if there is no preliminary tuner in the content storage, and stores the reservation recording data having a valid unit of reservation recording data structure in the storage unit 105.

In addition, supposing that there is a preliminary tuner in the content storage, if the reservation recording data having a valid unit of reservation recording is overlapped with at least one of the reservation recording data stored in the storage unit 105 for the reservation period, the day-of-the-week pattern, and the reservation time, but not for the additional data, the overlap check unit 104 stores the reservation recording data having a valid unit of reservation recording data structure in the storage unit 105.

In this case, the reservation recording data stored in the storage unit 105 has a reservation recording data structure shown in FIG. 6. Therefore, if there is an allowance for the reservation recording of a TV program broadcasted at 10:00 am˜11:00 am on every Tuesday and Wednesday from Nov. 1, 2005 to Nov. 30, 2005 in a channel CH11, the storage unit 105 stores the data representing 2005.11.01/10:00am/2005.11.30./11:00am/Tuesday,Wednesday/CH11 as the reservation recording data.

Therefore, supposing the allowed reservation recording data indicates that a program should be repeatedly recorded for three days of every week for one year, if a related art reservation recording function is used, 156 pieces of reservation recording data (52×3=156) should be stored. On the contrary, according to the present invention, only one piece of reservation recording data is stored.

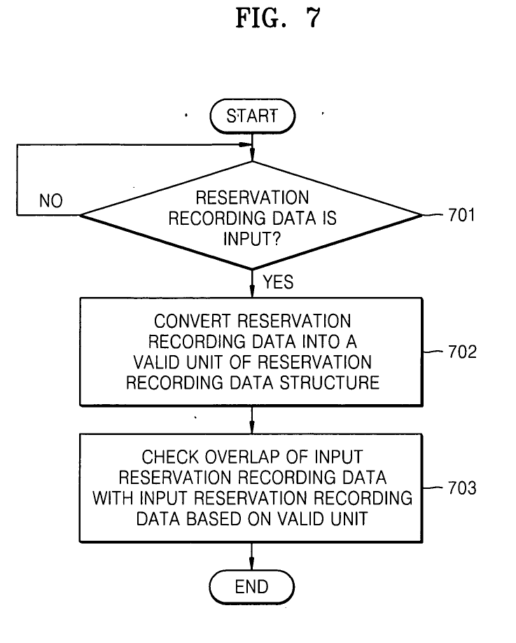

FIG. 7 is a flowchart illustrating a method of checking overlap of a reservation recording according to another exemplary embodiment of the present invention, which can be applied to various content storages.

Referring to FIG. 7, according to the method of the present invention, when desired reservation recording data is input (701), the input reservation recording data is converted into a valid unit of reservation recording data structure (702). In other words, if additional data is contained in the input reservation recording data, the input reservation recording data is not converted into the reservation recording data structure shown in FIG. 3, whereas if additional data is contained in the input reservation recording data, the input reservation recording data is converted into the reservation recording data structure shown in FIG. 6.

Then, based on the valid unit, it is checked whether the reservation recording data having a valid unit of reservation recording data structure is overlapped with the reservation recording data stored in the content storage (703). The reservation recording data stored in the content storage is the data that the reservation is allowed by the content storage.

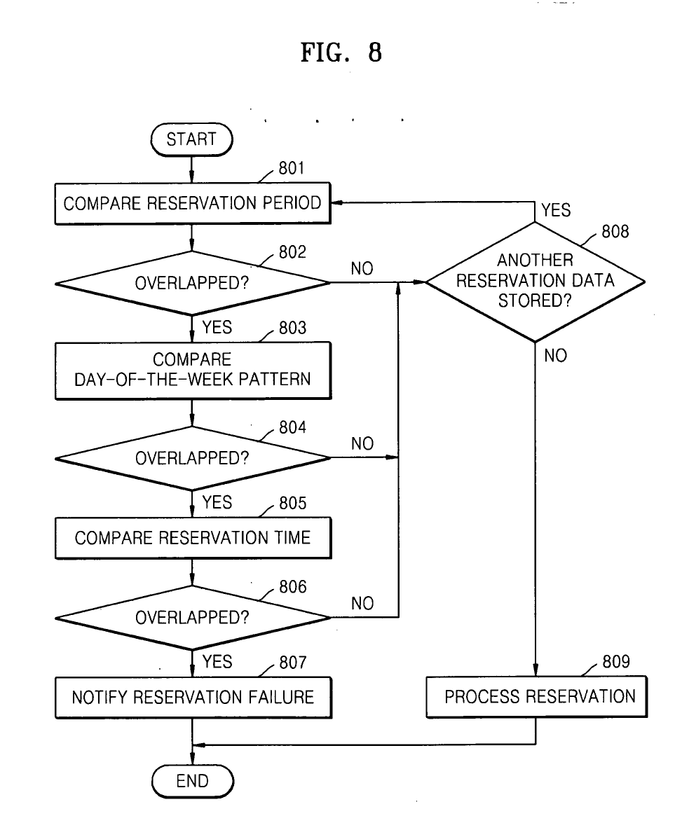

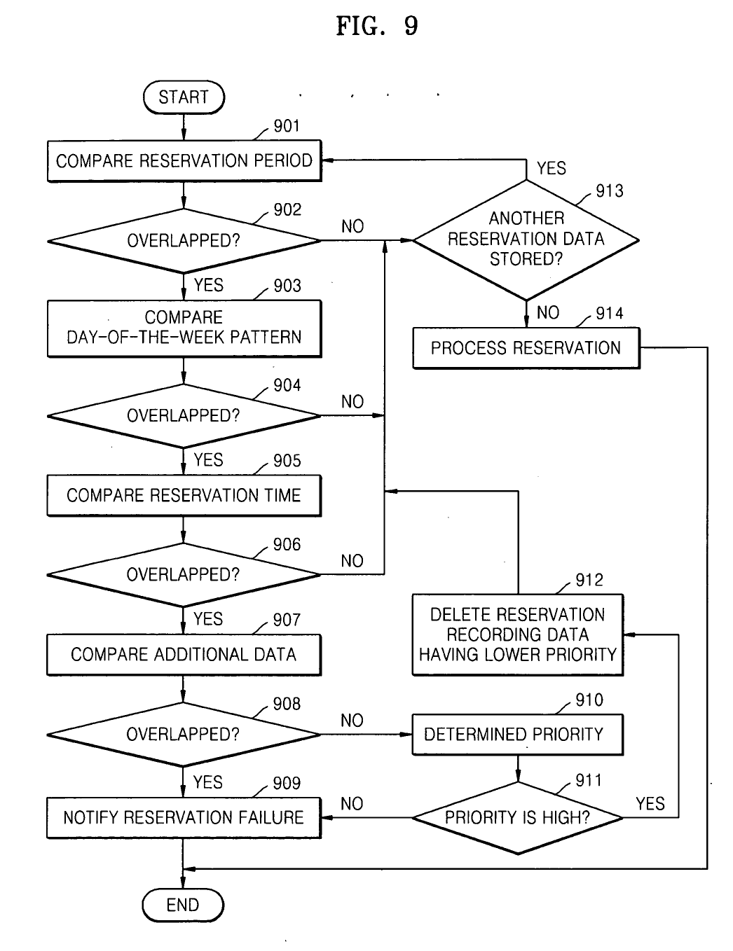

The reservation recording data overlap check in operation 703 can be performed as shown in FIG. 8. FIG. 8 is a flowchart illustrating an example of a reservation recording data overlap check of FIG. 7. FIG. 8 shows a case that the reservation recording data having a valid unit of reservation recording data structure has a reservation recording data structure shown in FIG. 3.

Referring to FIG. 8, the reservation recording data overlap check is performed in the order of the reservation period, the day-of-the-week pattern, and the reservation time.

In other words, the reservation recording data having a valid unit of reservation recording data structure is compared with the reservation recording data stored in the content storage for the reservation period based on the reservation start date and the reservation end date of the desired reservation data as well as the reservation start date and the reservation end date of the reservation recording data stored in the content storage (801).

As a result of comparison, if it is determined that the reservation periods are overlapped, the reservation recording data having a valid unit of reservation recording data structure is compared with the reservation recording data stored in the content storage for the day-of-the-week pattern according to the aforementioned method (802, 803). The comparison of the day-of-the-week pattern is performed as described above in association with FIG. 4. As a result of the comparison of the day-of-the-week pattern, if it is determined that the reservation recording data having a valid unit of reservation recording data structure is overlapped with the reservation recording data stored in the content storage for the day-of-the-week pattern, the reservation recording data having a valid unit of reservation recording data structure is compared with the reservation recording data stored in the content storage for the reservation time (804, 805).

If it is determined that the reservation times are overlapped, reservation failure for the reservation recording data having a valid unit of reservation recording data structure is notified (806, 807), and reservation operation for the input reservation recording data is terminated.

In other words, if the reservation recording data having a valid unit of reservation recording data structure is overlapped with at least one of the reservation recording data stored in the content storage for the reservation period, the day-of-the-week pattern, and the reservation time, reservation failure for the input reservation recording data is notified.

However, according to the aforementioned method, if it is determined that, in operation 802, the reservation recording data having a valid unit of reservation recording data structure is not overlapped with the reservation recording data stored in the content storage for the reservation period, if it is determined that, in operation 804, the reservation recording data having a valid unit of reservation recording data structure is not overlapped with the reservation recording data stored in the content storage for the day-of-the-week pattern, or if it is determined that, in operation 806, the reservation recording data having a valid unit of reservation recording data structure is not overlapped with the reservation recording data stored in the content storage for the reservation time, it is checked whether another reservation recording data that has not been compared with the reservation recording data having a valid unit of reservation recording data structure is stored in the content storage (808).

As a result of the check, if it is determined that another reservation recording data that has not been compared is stored, from the process returns to operation 801. On the contrary, if it is determined that another reservation recording data that has not been compared is not stored, a reservation processing for the input reservation recording data is performed (809), and a process is terminated.

According to the process shown in FIG. 8, if the reservation recording data having a valid unit of reservation recording data structure is not overlapped with all the reservation recording data stored in the content storage for at least one of the reservation period, the day-of-the-week pattern, and the reservation time, the reservation recording data having a valid unit of reservation recording data structure is reserved. Accordingly, the reservation recording data having a valid unit of reservation recording data structure of the input reservation recording data is stored in the content storage.

FIG. 9 is a flowchart illustrating another example of the reservation recording data overlap check shown in FIG. 7. FIG. 9 is made by considering a multi-user environment, in which the reservation recording data having a valid unit of reservation recording data structure has a reservation recording data structure shown in FIG. 6. Therefore, in FIG. 9, the overlap check is performed in the order of the reservation period, the day-of-the-week pattern, the reservation time, and the additional data.

Operations 901 through 909 of FIG. 9 are similar to operations 801 through 806 of FIG. 8. Accordingly, if the reservation recording data having a valid unit of reservation recording data structure is overlapped with at least one of the reservation recording data stored in the content storage for the reservation period, the day-of-the-week pattern, the reservation time, and the additional data, reservation failure for the input reservation recording data is notified, and reservation operation for the input reservation recording data is terminated. In this case, the additional data may include data on user's priorities.

As a result of the check of operation 908, if the reservation recording data having a valid unit of reservation recording data structure is not overlapped with the reservation recording data stored in the content storage for the additional data, this means that users who input the two kinds of reservation recording data are different. Accordingly, if the additional data are not overlapped, according to the aforementioned method, priorities between the two kinds of reservation recording data are determined (909, 910). Determination of the priority is performed based on the data contained in the additional data of the two kinds of reservation recording data. For example, if a user who currently inputs the reservation recording data has a higher priority than the other user who has already input the reservation recording data, the reservation recording data that is being currently input is determined to have a higher priority. After the priority is determined, according to the aforementioned method, it is check whether the currently input reservation recording data has a higher priority (911).

If it is determined that the currently input reservation recording data does not have a higher priority, according to the aforementioned method, reservation failure is notified, and reservation operation for the currently input reservation recording data is terminated (911, 909).

However, if it is determined that the currently input reservation recording data has a higher priority, according to the aforementioned method, the reservation recording data that has been already stored and has a lower priority is deleted (912), and a process advances to operation 913. If there is another reservation recording data that has not been compared with the reservation recording data having a valid unit of reservation recording data structure in the content storage, the process returns to operation 901. On the contrary, if there is no reservation recording data that has not been compared with the input reservation recording data in the content storage, a reservation processing for the input reservation recording data is performed (914). Accordingly, the reservation recording data having a valid unit of reservation recording data structure for the input reservation recording data is stored in the content storage.

Subsequently, according to the method shown in FIG. 9, if the reservation recording data having a valid unit of reservation recording data structure is not overlapped with all the reservation recording data stored in the content storage for at least one of the reservation period, the day-of-the-week pattern, and the reservation period, the data recording structure having a valid unit of reservation recording data structure is reserved.

In addition, in FIG. 9, if the reservation recording data having a valid unit of reservation recording data structure is overlapped with at least one of the reservation recording data stored in the content storage for the reservation period, the day-of-the-week pattern, and the reservation time, but not for the additional data, and if the reservation recording data having a valid unit of reservation recording data structure has a higher priority than at least one of the reservation recording data stored in the content storage, the at least one of the reservation recording data stored in the content storage is deleted, and the reservation recording data having valid unit of reservation recording data structure is reserved.

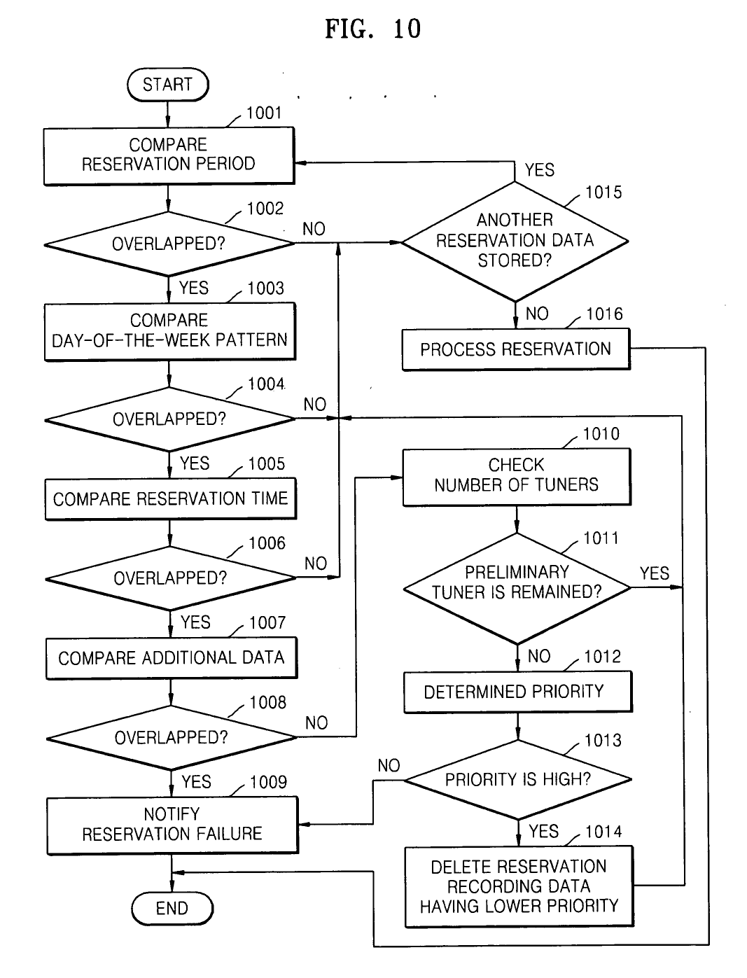

FIG. 10 is a flowchart illustrating still example of operation of the reservation recording data overlap check shown in FIG. 7. FIG. 10 is made by considering a content storage having a multi-tuner and/or a multi-user environment, and shows a case that the reservation recording data having a valid unit of reservation recording data structure has a reservation recording data structure shown in FIG. 6. Accordingly, the overlap check shown in FIG. 10 is performed in the order of the reservation period, the day-of-the-week pattern, the reservation period, and the additional data.

Operations 1001 through 1009 of FIG. 10 are similar to operations 901 through 909 of FIG. 9. Therefore, if the reservation recording data having a valid unit of reservation recording data structure is overlapped with at least one of the reservation recording data stored in the content storage for the reservation period, the day-of-the-week pattern, the reservation time, and the additional data, reservation failure for the input reservation recording data is notified, and reservation operation for the input reservation recording data is terminated.

On the contrary, if it is determined that the additional data is not overlapped, according to the aforementioned method, the number of the tuners is checked (1010). The check is performed by using the number of tuners provided in the content storage at this time and the number of overlapped programs. As a result of the check, if preliminary tuner remain (1011), the process advances to operation 1015, and it is checked whether there is another reservation recording data that has not been compared with the reservation recording data having a valid unit of reservation recording data structure in the content storage. If there is a preliminary tuner, this means that the number of the overlapped reservation recording data is smaller than the number of the multi-tuner provided in the content storage.

On the contrary, if there is no preliminary tuner, priorities of the reservation recording data having a valid unit of reservation recording data structure and the reservation recording data stored in the content storage are determined (1012). In this case, the priority may be channel information or a user's priority.

If the input reservation recording data has a lower priority, according to the aforementioned method, the process advances from operation 1013 to operation 1009, reservation failure is notified, and reservation operation is terminated.

However, the input reservation recording data has a higher priority, according to the aforementioned method, the reservation recording data that has been compared with the reservation recording data having a valid unit of reservation recording data structure and has a lower priority is deleted from the content storage (1014). Then, the process advances to operation 1015, and it is checked whether there is another reservation recording data that has not compared with the reservation recording data having a valid unit of reservation recording data structure. If there is no other reservation recording data in the content storage, a reservation processing for the input reservation recording data is performed (1016).

Accordingly, in FIG. 10, the reservation recording data having a valid unit of reservation recording data structure is not overlapped with all the reservation recording data stored in the content storage for at least one of the reservation period, the day-of-the-week pattern, and the reservation time, the reservation recording data having a valid unit of reservation recording data structure is reserved.

In addition, in FIG. 10, if the reservation recording data having a valid unit of reservation recording data structure is overlapped with at least one of the reservation recording data stored in the content storage for the reservation period, the day-of-the-week pattern, and the reservation time, but not for the additional data, and if there is a preliminary tuner in the content storage, the reservation recording data having a valid unit of reservation recording data structure is reserved.

In addition, in FIG. 10, if the reservation recording data having a valid unit of reservation recording data structure is overlapped with at least one of the reservation recording data stored in the content storage for the reservation period, the day-of-the-week pattern, and the reservation time, but not for the additional data, if the reservation recording data having a valid unit of reservation recording data structure has a higher priority than at least one of the reservation recording data stored in the content storage, and if there is no preliminary tuner in the content storage, at least one of the reservation recording data stored in the content storage is deleted, and the reservation recording data having a valid unit of reservation recording data structure is reserved.

According to the exemplary embodiments of the present invention, it is possible to check overlap of reservation recordings faster and easier as well as to reduce the amount of the reservation recording data stored in a repeated reservation recording mode by using a simplified reservation recording data structure in various types of content storages, thereby increasing an available reservation recording period.

In addition, it is possible to check overlap of a reservation recording faster with a small amount of operations by checking overlap of a reservation recording using bit operation based on a valid unit and a day-of-the-week pattern.

In addition, it is possible to perform the reservation recording overlap check considering channels and user's priorities by checking overlap of a reservation recording using the reservation recording data structure including the additional data field in various types of content storages. Therefore, it is possible to extend the field of application for the reservation recording overlap check depending on operating conditions and environments of the content storage (e.g., a multi-tuner environment or a multi-user environment).

The aforementioned effects can be doubled in a repeated reservation recording.

The exemplary embodiments of the present invention can be written as computer codes and can be implemented in general-use digital computers that execute the computer codes using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable codes are stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. Therefore, the scope of the invention is defined by the appended claims, and all differences within the scope will be construed as being included in the present invention.

1. A method of checking overlap of reservation recordings in a content storage, the method comprising:
converting input reservation recording data into a valid unit of reservation recording data; and
checking whether the valid unit of reservation recording data is overlapped with at least one of reservation recording data stored in the content storage based on the valid unit.

2. The method of claim 1, wherein the checking whether the valid unit of reservation recording data is overlapped comprises:
notifying the input reservation recording data of reservation failure if the valid unit of reservation recording data is overlapped with the at least one of the reservation recording data stored in the content storage; and
reserving the valid unit of reservation recording data if the valid unit of reservation recording data is not overlapped with all of the reservation recording data stored in the content storage.

3. The method of claim 1, wherein the checking whether the valid unit of reservation recording data is overlapped comprises checking whether the valid unit of reservation recording data is overlapped with the at least one of reservation recording data stored in the content storage for a reservation period, a day-of-the-week pattern, and a reservation time, in sequential order.

4. The method of claim 1, wherein the checking whether the valid unit of reservation recording data is overlapped comprises checking whether the valid unit of reservation recording data is overlapped with the at least one of reservation recording data stored in the content storage for a reservation period, a day-of-the-week pattern, a reservation time, and an additional data, in sequential order.

5. The method of claim 2, wherein the checking whether the valid unit of reservation recording data is overlapped comprises checking whether the valid unit of reservation recording data is overlapped with the at least one of reservation recording data stored in the content storage for a reservation period, a day-of-the-week pattern, a reservation time, and an additional data, in sequential order.

6. The method of claim 5, wherein the checking whether the valid unit of reservation recording data is overlapped further comprises:
deleting the at least one of the reservation recording data stored in the content storage and reserving the valid unit of reservation recording data if the valid unit of reservation recording data is overlapped with the at least one of the reservation recording data stored in the content storage for the reservation period, the day-of-the-week pattern, and the reservation time, and is not overlapped for the additional data, and if the valid unit of reservation recording data has a higher priority than that of the at least one of the reservation recording data stored in the content storage.

7. The method of claim 5, wherein the checking whether the valid unit of reservation recording data is overlapped further comprises:
reserving the valid unit of reservation recording data if the valid unit of reservation recording data is overlapped with the at least one of the reservation recording data stored in the content storage for the reservation period, the day-of-the-week pattern, and the reservation time, but is not overlapped for the additional data, and if there is a preliminary tuner in the content storage; and
deleting the at least one of the reservation recording data stored in the content storage and reserving the valid unit of reservation recording data if the valid unit of reservation recording data is overlapped with the at least one of the reservation recording data stored in the content storage for the reservation period, the day-of-the-week pattern, and the reservation time, but is not overlapped for the additional data, if the valid unit of reservation recording data has a higher priority than that of the at least one of the reservation recording data stored in the content storage, and if there is no preliminary tuner in the content-storage.

8. The method of claim 6, wherein the priority is determined based on priority data or channel data contained in the additional data of each reservation recording data.

9. The method of claim 3, wherein in the checking whether the valid unit of reservation recording data is overlapped, the reservation time is corrected if a reservation start time is larger than a reservation end time, and the checking whether the valid unit of reservation recording data is overlapped for the reservation time is performed based on the corrected reservation time.

10. The method of claim 5, wherein in the checking whether the valid unit of reservation recording data is overlapped, the reservation time is corrected if a reservation start time is larger than a reservation end time when the overlap check of the reservation time is performed, and the checking whether the valid unit of reservation recording data is overlapped for the reservation time is performed based on the corrected reservation time.

11. The method of claim 1, wherein the valid unit of reservation recording data comprises a reservation start date field, a reservation start time field, a reservation end date field, a reservation end time field, and a day-of-the-week pattern field.

12. The method of claim 1, wherein the valid unit of reservation recording data comprises a reservation start date field, a reservation start time field, a reservation end date field, a reservation end time field, a day-of-the-week pattern field, and an additional data field.

13. An apparatus for checking overlap of reservation recordings in a content storage, the apparatus comprising:
a parser which parses input reservation recording data;
a day-of-the-week data supply unit which provides day-of-the-week data;
a data conversion unit which converts the input reservation recording data into a valid unit of reservation recording data based on parsed data from the parser and the day-of-the-week data provided by the day-of-the-week data supply unit;
a storage unit which stores reservation data; and
an overlap check unit which checks whether the valid unit of reservation recording data is overlapped with reservation recording data stored in the storage unit.

14. The apparatus of claim 13, wherein the data conversion unit comprises:
a date converter which converts a reservation date data provided from the parser into reservation date bit data and outputs the reservation date bit data;
a time converter which converts a reservation time data provided from the parser into reservation date bit data and outputs the reservation time bit data; and
a day-of-the-week pattern generator which generates day-of-the-week pattern data based on the reservation date bit data output from the date converter, the reservation time bit data output from the time converter, and one of the day-of-the-week data provided by the day-of-the-week data supply unit and day-of-the-week data provided by the parser, and outputs the day-of-the-week pattern data,
wherein the valid unit of reservation recording data comprises the reservation date bit data, the reservation time bit data and the day-of-the-week pattern data.

15. The apparatus of claim 13, wherein the overlap check unit checks whether the valid unit of reservation recording data is overlapped with the reservation recording data stored in the storage unit for a reservation period, a day-of-the-week pattern, and a reservation time, in sequential order.

16. The apparatus of claim 13, the overlap check unit outputs a reservation failure notification for the input reservation recording data if the valid unit of reservation recording data is overlapped with at least one of the reservation recording data stored in the storage unit; and
the valid unit of reservation recording data reserves in the storage unit if the valid unit of reservation recording data is not overlapped with all of the reservation recording data stored in the content storage.

17. The apparatus of claim 14, wherein the data conversion unit further comprises an additional data converter which converts additional data provided from the parser into bit data and outputs the converted bit data,
wherein the valid unit of reservation recording data further comprises the converted bit data.

18. The apparatus of claim 14, wherein the overlap check unit corrects the reservation time data if it is determined based on the reservation time bit data that a reservation start time is larger than a reservation end time and performs the overlap check based on the corrected reservation time data.

19. The apparatus of claim 13, wherein the overlap check unit checks whether the valid unit of reservation recording data is overlapped with the reservation recording data stored in the storage unit for a reservation period, a day-of-the-week pattern, a reservation time, and additional data, in sequential order, and wherein the overlap check unit deletes at least one of the reservation recording data stored in the content storage, and stores the valid unit of reservation recording data in the storage unit if the valid unit of reservation recording data is overlapped with at least one of the reservation recording data stored in the content storage for the reservation period, the day-of-the-week pattern, and the reservation time, but is not overlapped for the additional data, and if the valid unit of reservation recording data has a higher priority than that of at least one of the reservation recording data stored in the storage unit.

20. The apparatus of claim 13, wherein the overlap check unit checks whether the valid unit of reservation recording data is overlapped with the reservation recording data stored in the storage unit for a reservation period, a day-of-the-week pattern, a reservation time, and additional data, in sequential order, and wherein overlap check unit stores the valid unit of reservation recording data in the storage unit if the valid unit of reservation recording data is overlapped with at least one of the reservation recording data stored in the content storage for the reservation period, the day-of-the-week pattern, and the reservation time, but is not overlapped for the additional data, and if there is a preliminary tuner in the storage unit.

21. A computer-readable medium having embodied thereon a computer program for executing a method of checking overlap of reservation recordings in a content storage, the method comprising:
converting input reservation recording data into a valid unit of reservation recording data; and
checking whether the valid unit of reservation recording data is overlapped with at least one of reservation recording data stored in the content storage based on the valid unit.
